(19) United States
(12) Patent Application Publication
(10) Pub. No.: US 2013/0292527 A1
(43) Pub. Date: Nov. 7, 2013

(54) VERTICALLY MOVABLE STAND FOR DISPLAY DEVICE

(71) Applicants: Yoshihito Mochizuki, Tokyo (JP); Hsi-ming Chen, Tokyo (JP)

(72) Inventors: Yoshihito Mochizuki, Tokyo (JP); Hsi-ming Chen, Tokyo (JP)

(21) Appl. No.: 13/816,208

(22) PCT Filed: Aug. 17, 2010
(86) PCT No.: PCT/JP2010/063841

§ 371 Date: Jul. 17, 2013

(51) Int. Cl. F16M 11/00

(52) U.S. Cl. CPC F16M 11/00
USPC 248/161

(57) ABSTRACT

A vertically movable stand for a display device includes: a guide member which is fixed on a base member; a vertically movable member which is vertically movably attached on the guide member, and supports a display; a first friction part which is provided between the guide member and the vertically movable member; and a second friction part which is provided between the guide member and the vertically movable member, at a position displaced from the first friction part toward a side of the base member. A frictional force of the second friction part is set greater than a frictional force of the first friction part.

### TECHNICAL FIELD

The present invention relates to a vertically movable stand for a display device, which vertically movably supports various types of displays such as a liquid crystal display.

### BACKGROUND ART

In recent years, as a display monitor for a personal computer, a television set, or the like, flat-screen display devices such as liquid crystal displays and plasma displays are widely prevalent. These display devices include one that is supported by a vertically movable stand. This vertically movable stand includes a height adjusting mechanism that is capable of adjusting the heightwise position of a display to suit the eye height of an observer.

As a display device including this type of vertically movable stand, there is a display stand disclosed in Patent Document 1 for example.

This stand is such that a vertically movable member including a display is vertically movably fitted into a guide member supported on a base part, the guide member and the vertically movable member are both formed in sectionally substantially rectangular shapes, and between both of these members, there is provided a friction mechanism that uses a one-way clutch. This friction mechanism is configured such that the vertically movable member is biased upward using an elastic member composed of a conston spring, and when the vertically movable member is manually lifted upward, the guide member of the friction mechanism moves slightly upward to thereby lower the level of pressing force of a plate spring of the one-way clutch, and moves the vertically movable member upward with a light force.

Alternatively, as a friction mechanism, for the conston spring, there is provided a torque limiter, so that when the vertically movable member is raised, the level of the winding force of the spring with respect to a friction roller is lowered, to thereby facilitate rotation of the friction roller and raise the vertically movable member with a light force.

### PRIOR ART DOCUMENT

### Patent Document

[Patent Document 1] Japanese Unexamined Patent Application, First Publication No. 2005-300922

### SUMMARY OF THE INVENTION

### Problem to be Solved by the Invention

However, in the above display stand, vertical movement of the vertically movable member with respect to the guide member is controlled using a pair of friction mechanisms provided at a single location, and a heavy display is attached to the vertically movable member. Therefore, there is a problem in that as the display is repeatedly raised and lowered, load associated with friction concentrates on the portion of the friction mechanism, and it may be damaged as a result. Moreover, there is also a problem in that when the friction mechanism is dependent on the elastic member at a single location, the operability of the raising/lowering operation may be degraded, and the vertically movable member may be tilted in some cases.

The present invention takes into consideration the above circumstances, with an object of providing a vertically movable stand for a display device which improves the level of operability and durability without a concentrated load associated with friction.

### Means for Solving the Problem

A vertically movable stand for a display device according to the present invention includes: a guide member which is fixed on a base member; a vertically movable member which is vertically movably attached on the guide member, and supports a display; a first friction part which is provided between the guide member and the vertically movable member; and a second friction part which is provided between the guide member and the vertically movable member, at a position displaced from the first friction part toward a side of the base member, a frictional force of the second friction part set greater than a frictional force of the first friction part.

The vertically movable stand for a display device according to the present invention is such that the first and second friction parts are provided so as to be displaced in the vertical movement direction, between the guide member and the vertically movable member that supports a display. Therefore, when vertically moving the vertically movable member that supports a display, with respect to the guide member, frictional forces for sliding and maintaining a static state are distributed and exerted to the first and second friction parts in the vertical movement direction. Hence there will not be an excessive level of load exerted on one of the friction parts, and superior operability and durability are achieved.

In addition, since the frictional force of the second friction part is set greater than the frictional force of the first friction part, an excessive load can be prevented from being exerted on the connection part between the guide member and the vertically movable member where the first friction part is provided, to thereby prevent tilting of and damage to the vertically movable member.

Moreover, it is preferable that the second friction part includes a contact part fixed on the vertically movable member, the contact part elastically deformably coming in contact with an inner surface of the guide member to produce a frictional force.

By employing this type of configuration for the second friction part, the vertically movable member can make smooth vertical movements, and the vertically movable member can be brought to a static state at an arbitrary position with frictional force between the contact part and the inner surface of the guide member.

Moreover, the first friction part may include a guide friction part provided between the guide member and the vertically movable member, in a vicinity of an upper opening of the guide member.

As a result of the vertically movable member vertically moving the guide friction part provided in the vicinity of the upper opening of the guide member, as the first friction part, a frictional force smaller than that at the second friction part occurs between the vertically movable member and the guide friction part. Therefore, superior operability is achieved with vertical movement of the vertically movable member guided, and the vertically movable member will not be tilted or damaged at the first friction part.

Moreover, a column may be supported on an inner side of the guide member, and the vertically movable member may be provided vertically movable, between the guide member and the column.

The vertically movable stand of a triple structure is configured with the guide member, the vertically movable member, and the column, and in addition, the first friction part and the second friction part are provided between the guide member and the vertically movable member. Therefore, there can be obtained a stand which requires an occupying space smaller than that required conventionally.

Moreover, an elastic member connected to the vertically movable member may be provided on the column, and the elastic member may extend and contract according to vertical movement of the vertically movable member. Therefore, the vertically movable stand according to the present invention is capable of maintaining a static state while the frictional force associated with the first and second friction parts, its own weight, and the biasing force of the elastic member are balanced at an arbitrary position. The elastic member includes a spiral spring type coil spring.

### Effect of the Invention

As described above, according to the vertically movable stand for a display device of the present invention, since the first and second friction parts are provided between the guide member and the vertically movable member which supports a display device, the load will not be concentrated on a single friction part, and the load can be distributed and received on the first and second friction parts, thereby achieving superior operability and durability. In addition, since the frictional force of the second friction part of the vertically movable member, which slidably comes in contact with the inner surface of the guide member, is set greater than the frictional force of the first friction part, an excessive load can be prevented from being exerted on the connection part between the guide member and the vertically movable member where the first friction part is provided, to thereby prevent damage to the vertically movable stand and tilting of the vertically movable member.

### BRIEF DESCRIPTION OF THE DRAWINGS

FIG. 1 is a perspective view shown with a partially cutaway view of a vertically movable stand for a display device according to an exemplary embodiment of the present invention.

FIG. 2 is an exploded perspective view showing a relevant part of the vertically movable stand shown in FIG. 1.

FIG. 3 is an enlarged view of part A of the vertically movable stand shown in FIG. 1.

FIG. 4 is an explanatory view of the vertically movable member in FIG. 1.

FIG. 5 is an enlarged view of part B of the vertically movable member shown in FIG. 4.

FIG. 6 is a perspective view of a friction member shown in FIG. 5 seen from obliquely thereabove.

FIG. 7 is a sectional view showing the vertically movable stand where the vertically movable member is in an extended state.

FIG. 8 is a sectional view showing the vertically movable stand where the vertically movable member is in a contracted state.

### EMBODIMENTS FOR CARRYING OUT THE INVENTION

Hereunder, an exemplary embodiment of the present invention is described on the basis of the accompanying drawings.

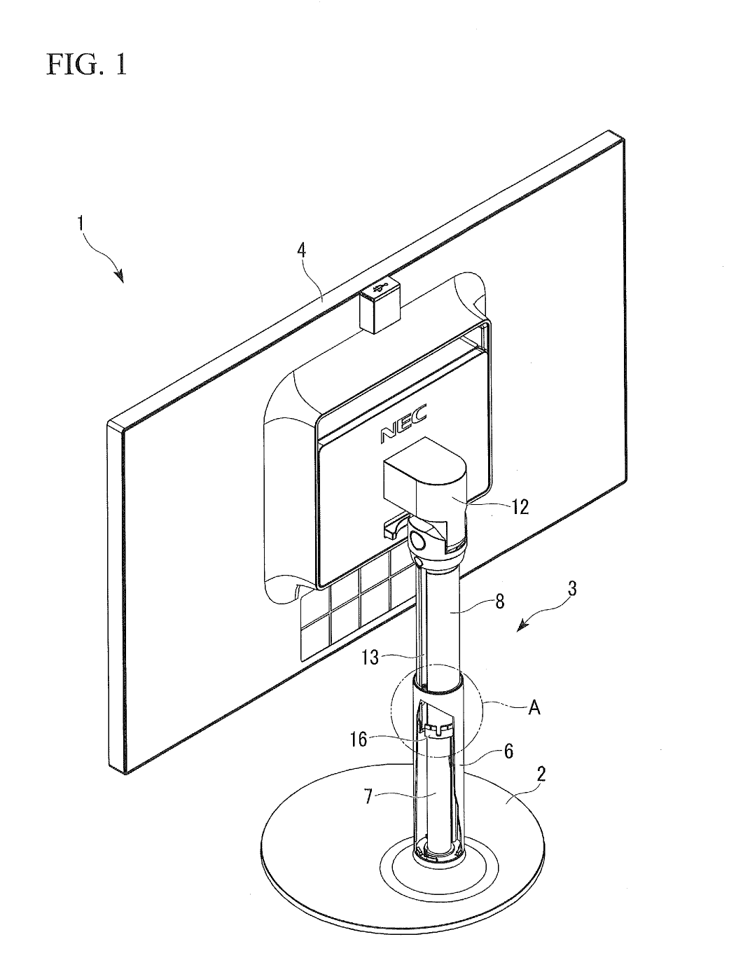

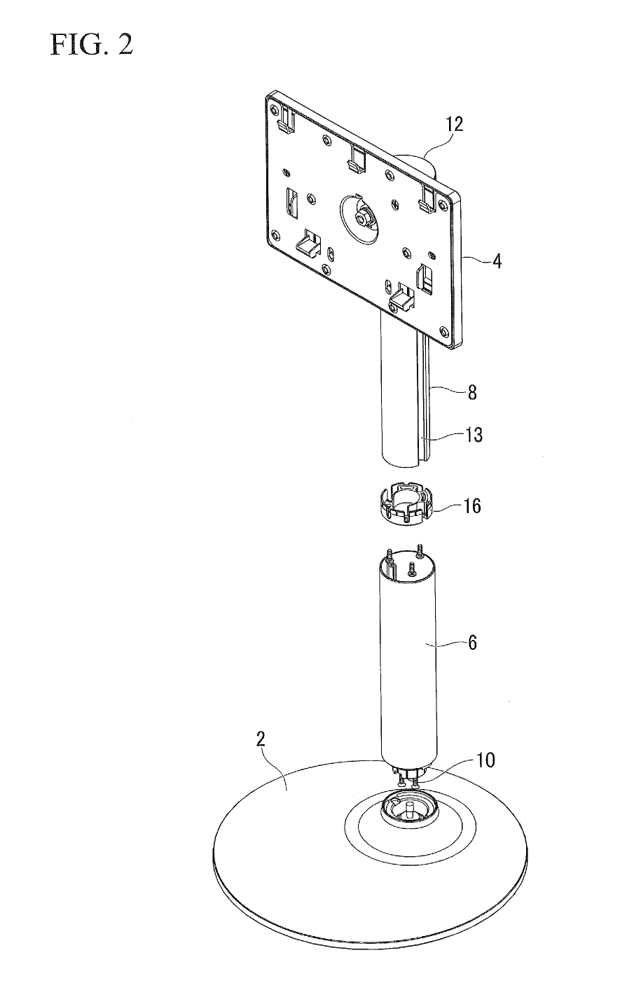

As shown in FIG. 1 and FIG. 2, a display device 1 is such that on a lower part of a vertically movable stand 3 which can be moved vertically, there is attached a base-shaped base member 2, and on an upper part of the vertically movable stand 3, there is attached a supporting part 4 for a display such as a liquid crystal display.

The vertically movable stand 3 is configured in a substantially triple cylinder shape configured by a guide member 6 fixed on the base member 2, a column 7 which is provided on the inner side thereof and which is fixed on the base member 2, and a vertically movable member 8 on the upper part of which there is attached the display supporting part 4, which is fitted in between the guide member 6 and the column 7, and which can be moved vertically. The column 7 is omitted in FIG. 2.

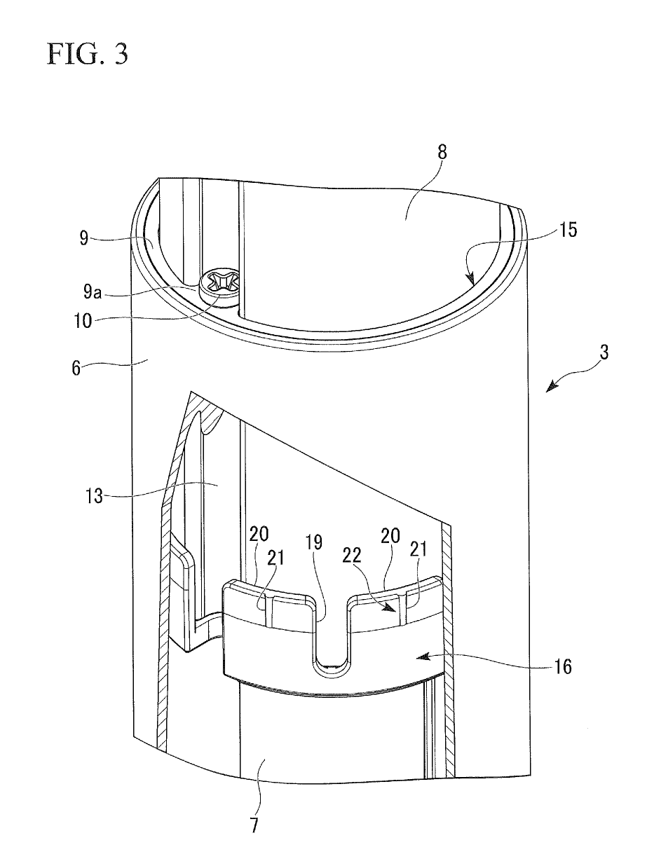

The guide member 6 and the column 7 are respectively formed in a substantially cylindrical shape, and the lower end parts thereof are integrated by a connection member (not shown in the figure). The substantially disc-shaped base member 2 is screwed on the lower end part of the integrated guide member 6 and the column 7, via the connection member. As shown in FIG. 3, on the inner surface of the upper end opening of the guide member 6, there is fixed a substantially ring-shaped guide ring 9. In FIG. 3, the guide ring 9 has a configuration such that at each of 180 degree-separated positions that are opposite to each other, a guide protrusion 9a projects toward the radially center side (only one of them is shown in the figure), and a bolt 10 is inserted through a through hole provided in this guide protrusion 9a, and is threadably fixed on an inner portion (not shown in the figure) of the guide member 6.

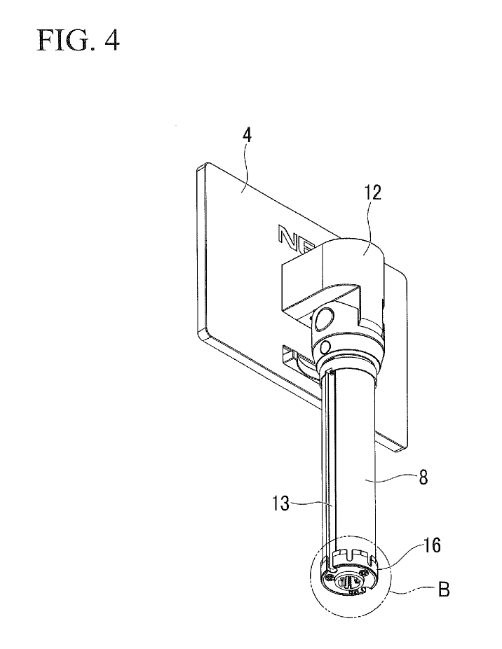

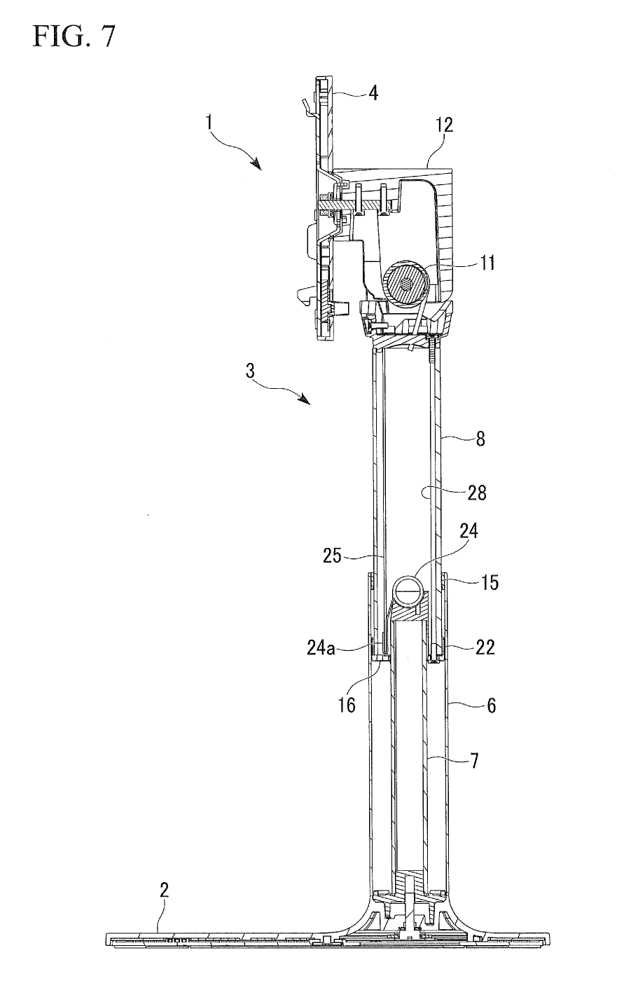

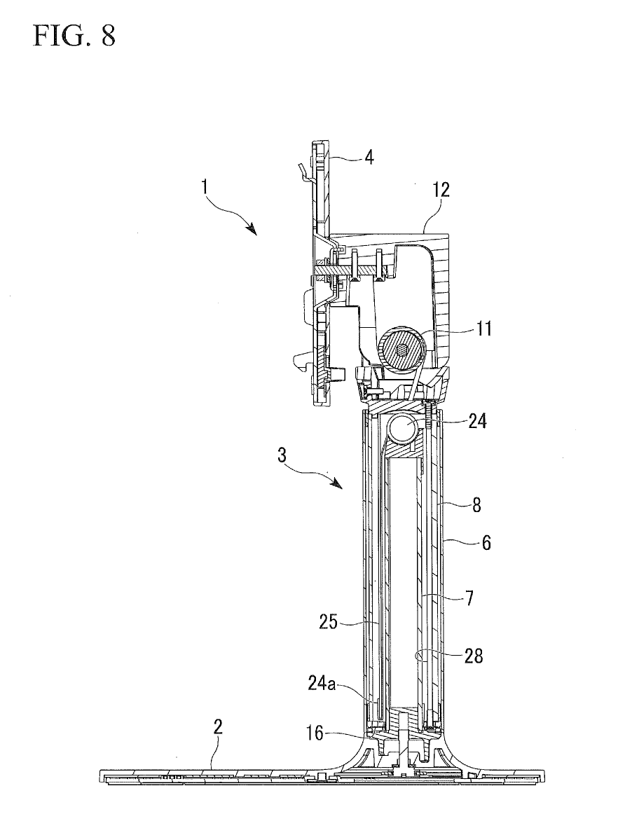

The vertically movable member 8 shown in FIG. 4 is of a substantially cylindrical shape, and on the upper part thereof, there is attached the display supporting part 4 while allowing it to left-right rotate and face-up rotate, via an attachment part 12 which has a built-in tilt mechanism 11 shown in FIG. 7 and FIG. 8. In the vertically movable member 8, at opposing positions that are 180 degree separated in the circumferential direction thereof, there are provided guide groove parts 13 which are respectively slidably fitted on the guide protrusions 9a of the guide ring 9 provided on the guide member 6. The guide groove parts 13 are formed in a linear shape along the lengthwise direction from the lower end of the vertically movable member 8 to the attachment part 12.

The vertically movable member 8 is inserted and fitted between the guide member 6 and the column 7, and vertical sliding movement thereof is guided in a state where the guide protrusion 9a of the guide ring 9 provided on the guide member 6 is fitted into the guide groove part 13. Therefore, the vertically movable member 8 and the guide ring 9 constitute a first friction part 15, and the vertically movable member 8 comes in contact with the entire circumference of the guide ring 9, thereby producing a comparatively small frictional force F1.

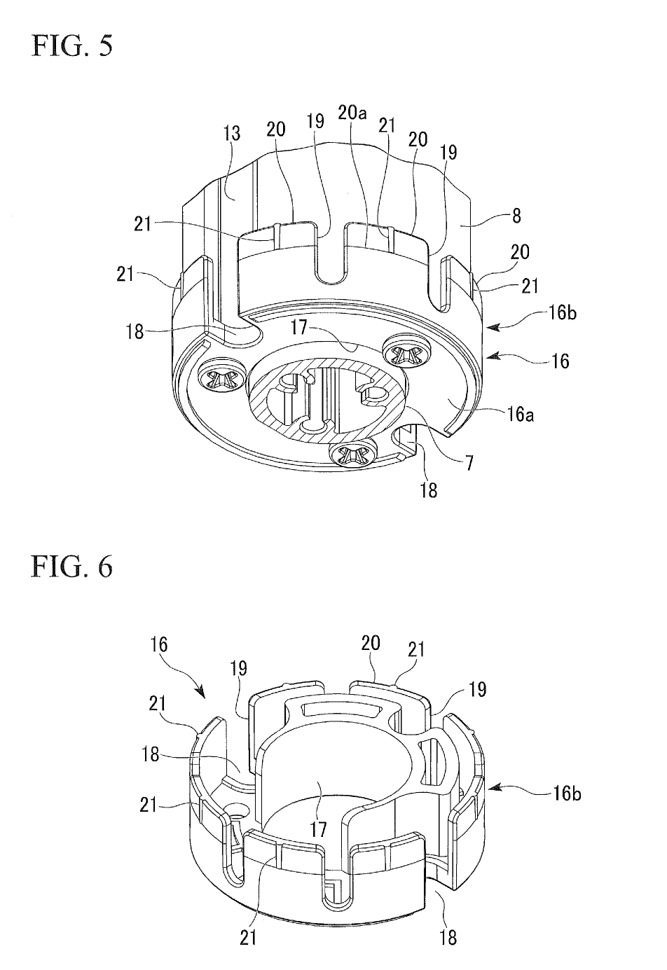

Moreover, on the lower end of the vertically movable member 8, there is fitted a substantially cylindrical bottom-ended friction member 16, and it is fixed by bolts 10 or the like. In FIG. 5 and FIG. 6, the friction member 16 is such that in the center of a bottom part 16a thereof, there is formed a guide hole 17 through which the column 7 is inserted, and the column 7 extends in the vertically movable member 8 by passing through the guide hole 17. Thereby, the column 7 and the guide member 6 guide vertical movement of the vertically movable member 8.

Moreover, in a substantially cylindrical side surface 16b of the friction member 16, at 180 degree-separated positions, there are formed a pair of concave parts 18 so as to align each with the guide groove part 13 of the vertically movable member 8. Moreover, slits 19 respectively extend from the upper end opening to the bottom part 16a at predetermined intervals between two of the concave parts 18. A plurality of contact pieces 20, which are partly divided by the slits 19, each have a free end part which can be elastically deformed in the radial direction at the base part thereof serving as a fulcrum point.

Furthermore, each contact piece 20 is such that the substantially heightwise center portion of the outer circumferential surface thereof foams a parting line 20a which projects radially outward, and thereabove, there is formed a friction convex part 21 which extends from the free end part to the parting line 20a and projects further radially outward. Therefore, in the vertically movable stand shown in FIG. 3, when the vertically movable member 8 moves vertically, the friction convex part 21 that projects further radially outward comes in contact with the inner circumferential surface of the guide member 6, thereby producing a frictional force F2. The contact piece 20 including the friction convex part 21 constitutes the contact part.

The parting line 20a means a border line of the substantially mountain-shaped tapered surfaces for mold release, serving as a border on the outer circumferential surface between two metal molds, after completion of the injection molding, when injection-molding the friction member 16 with metal molds for example. Here, the friction convex part 21 of the contact piece 20 of the friction member 16 and the inner circumferential surface of the guide member 6 constitute a second friction part 22 where they come in contact with each other and produce the frictional force F2.

The amount of radially outward protrusion of the friction convex part 21 of each contact piece 20 is set so that the frictional force F2 of the second friction part 22 is set greater than the frictional force F1 associated with the first friction part 15 mentioned above. The number of the friction convex parts 21 and the area of contact with the inner circumferential surface of the guide member 6 can be appropriately adjusted, and thereby, the magnitude of the frictional force F2 can be adjusted.

Next, a biasing mechanism provided in the vertically movable stand 3 is described, with reference to FIG. 7 and FIG. 8.

In the vertically movable stand 3 shown in FIG. 7 and FIG. 8, as an elastic member, a plate-shaped coil spring 24 composed of a conston spring is attached on the upper end part of the column 7, in a state of being wound on a supporting shaft so as to be able to be fed out and wound in. One end part 24a fed out from this coil spring 24 hook-engages with the lower end of an engagement part 25 which is provided on the inner surface side of the vertically movable member 8 in which there is attached the friction member 16 through which the column 7 is inserted.

As shown in FIG. 7, when the vertically movable stand 3 is in an extended state where the vertically movable member 8 has been raised from the interior of the guide member 6 and is projecting to the outside, the coil spring 24 is in a wind-in state where the hook-shaped one end part 24a is maintained in a position in the close vicinity of the coil spring 24 together with the lower end of the engagement part 25. Moreover, in FIG. 8, when the vertically movable stand 3 is in a contracted state where the vertically movable member 8 has been lowered and is accommodated within the guide member 6, the coil spring 24 is fed out, and the one end part 24a is maintained in a state of being separated from the wound part.

In the vertically movable stand 3, by manually operating the display supporting part 4 and the vertically movable member 8 to move them vertically, vertical movement thereof can be made smoothly. When the own weight of the display, and the frictional forces F1 and F2 of the first and second friction parts 15 and 22 are balanced with respect to the biasing force of the coil spring 24 that acts in the rising direction of the vertically movable member 8, the vertically movable member 8 comes into a static state at an arbitrary position.

The display device 1 including the vertically movable stand 3 according to the present exemplary embodiment includes the above configuration, and at the time of assembly, the guide member 6 and the column 7 of the vertically movable stand 3 are fixed using the bolts 10 or the like. Then, the friction member 16 is fitted and fixed on the lower end part of the vertically movable member 8 having the attachment part 12 attached on the upper part thereof. The coil spring 24 is supported on the upper part of the column 7, and the hook-shaped one end part 24a that has been fed out from the coil spring 24 is engaged with the lower end part of the engagement member 25 of the vertically movable member 8. Finally, the base member 2 is attached on the guide member 6 and the column 7 of the vertically movable stand 3.

In this state, the guide hole 17 of the friction member 16 is fitted on the column 7 and the vertically movable member 8 is inserted into the substantially cylindrical space between the guide member 6 and the column 7. Thereby, the friction convex parts 21 of the friction member 16 are brought into contact with the inner circumferential surface of the guide member 6 to install the second friction part 22.

Next, the guide ring 9 is positioned and maintained at the upper end opening of the guide member 6 so that the guide protrusion 9a fits in the guide groove part 13 of the vertically movable member 8, and the guide ring 9 is fixed on the guide member 6 with the bolts 10 or the like. Thereby, the first friction part 15 is installed.

Next, the display supporting part 4 is attached on the attachment part 12 that is fixed on the vertically movable member 8, and thereby the display device 1 provided with the vertically movable stand 3 is obtained.

Next is described the vertical movement operation of the display device 1 including the vertically movable stand 3 having the above configuration.

In the display device 1, in the state as shown in FIG. 1 and FIG. 7 where the vertically movable member 8 is maintained in the extended state, the coil spring 24 is in a wound-in state, and the vertically movable member 8 is biased in the rising direction with respect to the guide member 6 and is maintained in a static state by the frictional forces F1 and F2 of the first and second friction parts 15 and 22. Then, in order to lower the display supporting part 4, the vertically movable member 8 is pressed downward. Consequently, the vertically movable member 8 is lowered while the inner and outer circumferential surfaces thereof are guided respectively by the guide groove part 13, the guide protrusion 9a of the ring guide 9, the guide hole 17 of the friction member 16, and the column 7, against the biasing force of the coil spring 24 in the rising direction and the frictional forces F1 and F2 of the first and second friction parts 15 and 22.

At this time, the coil spring 24 is pressed by the engagement part 25 of the vertically movable member 8 and is fed out downward. At the same time, in the first friction part 15, the vertically movable member 8 is in surface contact with the inner side contact surface of the guide ring 9 at the upper end opening of the guide member 6, and is lowered against the frictional force F 1.

Moreover, in the second friction part 22, the friction convex part 21 of each contact piece 20 in the friction member 16 provided at the lower end of the vertically movable member 8 is slide-lowered against the frictional force F2 while being in contact with the inner circumferential surface of the guide member 6.

If the vertically movable member 8 is released from the hand at an arbitrary position, the sum of the frictional force F1 of the first friction part 15, the frictional force F2 of the second friction part 22, and the gravitational force acting on the display is balanced with respect to the biasing force of the coil spring 24 in the rising direction, and as a result, the vertically movable member 8 and the display can be brought to a static state.

Inversely, in the case where the display is raised from the contracted state where the vertically movable member 8 is accommodated in the guide member 6, when the vertically movable member 8 or the like is lifted by hand, the rising movement of the vertically movable member 8 causes the hook-shaped one end part 24a to approach the wound part of the coil spring 24 together with the lower end part of the engagement part 25, and the coil spring 24 is wound in gradually.

In response to this, the weight of the display acts downward, and the frictional force F1 of the first friction part 15 and the frictional force F2 of the second friction part 22 also act similarly to prevent the vertically movable member 8 from rising. As a result, if the hand is released at an arbitrary position, the sum of the frictional force F1 of the first friction part 15, the frictional force F2 of the second friction part 22, and the gravitational force acting on the display is balanced with respect to the biasing force of the coil spring 24, and as a result, the vertically movable member 8 can be brought to a static state.

The stop position where the vertically movable member 8 is raised the highest, is set at a position immediately before the contact piece 20 of the friction member 16 comes in contact with the guide ring 9 (refer to FIG. 7). Similarly, the stop position where the vertically movable member 8 is lowered the lowest is set at a position immediately before the coil spring 24 provided on the upper end of the column 7 comes in contact with the attachment part 12 (refer to FIG. 8). Therefore, as shown in FIG. 7 and FIG. 8, a regulating member 28 of a predetermined length that regulates the raised position and the lowered position of the vertically movable member 8, is installed between the top and the bottom of the vertically movable member 8.

As described above, according to the vertically movable stand 3 of the display device 1 of the present exemplary embodiment, the frictional forces F1 and F2 for suppressing raising/lowering operations of the vertically movable member 8 and bringing it to a static state at an arbitrary position, are produced at two locations of the first friction part 15 and the second friction part 22 which are displaced in the lengthwise direction of the vertically movable member 8. Therefore, without an excessive load being exerted on either one of them, vertical movement and a static state of the vertically movable member 8 can be reliably supported with the frictional forces F1 and F2, and in addition, it is possible to smoothly move it vertically and bring it to a static state without rattling.

In contrast, if the vertically movable member 8 is supported while allowing it to move vertically and come to a static state with a friction part at a single location as practiced in the conventional technique mentioned above, tilting or rattling may occur when operated to move vertically, and smooth vertical movements and stopping are not possible. Moreover, if a frictional force for stopping the vertically movable member 8 is concentrated to act on the friction part at a single location, there is also the disadvantage in that a large load is repeatedly exerted thereon and damage is likely to occur.

In addition, since the frictional force F1 of the first friction part 15 provided between the upper end opening of the guide member 6 and the vertically movable member 8 is set smaller than the frictional force F2 of the second friction part 22 provided therebelow, when the vertically movable member 8 is operated to move vertically, the load will not be concentrated on the upper end opening of the guide member 6 to cause rattling or damage.

In particular, since the frictional force F1 of the first friction part 15 is small, the surface of the vertically movable member 8 that is exposed to the outside of the guide member 6 will not be scratched, and the vertically movable member 8 will not be tilted. Moreover, since the frictional force F2 of the second friction part 22 positioned within the guide member 6 is comparatively large, vertical movement and stopping are performed smoothly, and even if the inner circumferential surface of the guide member 6 is scratched, it will not be exposed to the outside, thereby achieving a better appearance.

Moreover, as a result of providing the first and second friction parts 15 and 22 separately in the lengthwise direction of the vertically movable member 8, the individual friction parts can be made smaller, and the outer diameter size of the vertically movable stand 3 can be made smaller than that of the conventional one.

In the above exemplary embodiment, the guide groove parts 13 are provided in the vertically movable member 8, and the guide ring 9 and the guide protrusions 9a are formed on the inner surface of the upper end opening of the guide member 6. However, the guide groove parts 13 and the guide protrusions 9a are not always required to be provided. Even in this case, it is possible to produce the frictional force F1 with friction between the outer circumferential surface of the vertically movable member 8 and the inner circumferential surface of the guide ring 9.

Furthermore, in the first friction part 15, the guide ring 9 and the outer circumferential surface of the vertically movable member 8 constituting the guide friction part do not always have to be configured to come in contact with each other around the entire circumference to thereby exert the frictional force F1, and part of the guide ring 9 may be brought into contact with the vertically movable member 8 to produce the frictional force F1. By adjusting the contact area of the guide ring 9 with the outer circumferential surface of the vertically movable member 8, the frictional force F1 can be adjusted.

Moreover, in the second friction part 22, the friction member 16 does not always have to be formed as a separate member from the vertically movable member 8, and they may be integrally formed. That is, it is sufficient that an elastically deformable friction convex part 21 is provided on the vertically movable member 8.

The column 7 does not always have to be provided as a member that contacts the vertically movable member 8 from the inside to guide it. For example, as long as it supports the coil spring 24, it may be of a small diameter to an extent that it does not contact and is separated from the guide hole 17 of the friction member 16.

### INDUSTRIAL APPLICABILITY

The present invention provides a vertically movable stand such that in a vertically movable stand for a display device with a display attached thereon, first and second friction parts are provided at two locations in the vertical direction of a vertically movable member that can be moved vertically with respect to a guide member, and by setting the frictional force of the second friction part greater than the frictional force of the first friction part, vertical movement of the vertically movable member with respect to the guide member is made smooth without rattling, to thereby prevent damage thereto.

### REFERENCE SYMBOLS

1 Display device
2 Base member
3 Vertically movable stand
4 Display supporting part
6 Guide member
7 Column
8 Vertically movable member
9 Guide ring
9a Guide protrusion
13 Guide groove part
15 First friction part
16 Friction member
17 Guide hole
20 Contact piece
21 Friction convex part
22 Second friction part
24 Coil spring

1. A vertically movable stand for a display device, comprising:
a guide member which is fixed on a base member;
a vertically movable member which is vertically movably attached on the guide member, and supports a display;
a first friction part which is provided between the guide member and the vertically movable member; and
a second friction part which is provided between the guide member and the vertically movable member, at a position displaced from the first friction part toward a side of the base member, a frictional force of the second friction part set greater than a frictional force of the first friction part.

2. The vertically movable stand according to claim 1, wherein the second friction part includes a contact part fixed on the vertically movable member, the contact part elastically deformably coming in contact with an inner surface of the guide member to produce a frictional force.

3. The vertically movable stand according to claim 1, wherein the first friction part includes a guide friction part provided between the guide member and the vertically movable member, in a vicinity of an upper opening of the guide member.

4. The vertically movable stand according to claim 1, wherein a column is supported on an inner side of the guide member, and the vertically movable member is provided vertically movable, between the guide member and the column.

5. The vertically movable stand according to claim 4, wherein an elastic member connected to the vertically movable member is provided on the column, and the elastic member extends and contracts according to vertical movement of the vertically movable member.

6. The vertically movable stand according to claim 2, wherein the first friction part includes a guide friction part provided between the guide member and the vertically movable member, in a vicinity of an upper opening of the guide member.

7. The vertically movable stand according to claim 2, wherein a column is supported on an inner side of the guide member, and the vertically movable member is provided vertically movable, between the guide member and the column.

8. The vertically movable stand according to claim 3, wherein a column is supported on an inner side of the guide member, and the vertically movable member is provided vertically movable, between the guide member and the column.
